(19) United States
(12) Patent Application Publication
(10) Pub. No.: US 2023/0350196 A1
(43) Pub. Date: Nov. 2, 2023

(54) EXIT PUPIL EXPANDER

(71) Applicant: DISPELIX OY, Espoo (FI)

(72) Inventors: Hanna Lajunen, Espoo (FI); Toni Saastamoinen, Espoo (FI)

(73) Assignee: DISPELIX OY, Espoo (FI)

(21) Appl. No.: 17/999,957

(22) PCT Filed: May 25, 2021
(86) PCT No.: PCT/FI2021/050374

§ 371 Date: Nov. 28, 2022

(30) Foreign Application Priority Data
May 29, 2020 (FI) 20205559

(51) Int. Cl. G02B 27/00; G02B 5/18; G02B 27/01

(52) U.S. Cl. CPC G02B 27/0081; G02B 5/1819; G02B 27/0101

(57) ABSTRACT

According to an example aspect of the present invention, there is provided an Exit Pupil Expander, EPE, grating which is divided into at least two segments, wherein the EPE grating comprises multiple grating bars in a first segment and multiple grating bars in a second segment, said multiple grating bars of the first segment being directed about to a same direction as said multiple grating bars of the second segment and misaligned in a direction which is perpendicular to the direction of the grating bars.

### FIELD

Embodiments of the present invention relate in general to an Exit Pupil Expander, EPE, e.g., for an optical waveguide arrangement, such as for a waveguide-based display.

### BACKGROUND

In general, there is a need to provide improvements related to an Exit Pupil Expander, EPE. Light rays typically interfere in the EPE grating and hence cause non-uniformities into an out-coupled image. Therefore it is necessary to reduce the interference caused by light rays that interfere in the EPE grating.

For instance, US 2018/0052501 A1 discusses an EPE exhibiting wave interference caused by uniform grating in the Orthogonal Pupil Expander, OPE. The wave interference may be decreased, and luminance uniformity of the output image may be increased, for example, by varying grating parameters or materials, etc., at different locations.

However, such a solution does not enable tuning of the phase of diffracted light rays independently without altering the amplitude response of the gratings. That is to say, there is a need, in view of US 2018/0052501 A1, to provide more degrees of freedom for modifying the operation of an optical waveguide. Changing of a width, height and/or fill factor of grating bars would not provide the required effects either. Thus, there is a need to provide an improved EPE grating, e.g., for an optical waveguide arrangement.

### SUMMARY

According to some aspects, there is provided the subject-matter of the independent claims. Some embodiments are defined in the dependent claims.

According to a first aspect of the present invention, there is provided an Exit Pupil Expander, EPE, grating which is divided into at least two segments, wherein the EPE grating comprises multiple grating bars in a first segment and multiple grating bars in a second segment, said multiple grating bars of the first segment being directed about to a same direction as said multiple grating bars of the second segment and misaligned in a direction which is perpendicular to the direction of the grating bars.

Embodiments of the first aspect may comprise at least one feature from the following bulleted list or any combination of the following features:
said multiple grating bars of the first segment and said multiple grating bars of the second segment are misaligned to cause light rays propagating along different paths in the EPE grating to undergo different phase shifts;
each of said multiple grating bars in the second segment is offset compared to a corresponding grating bar in the first segment by a distance in the direction which is perpendicular to a direction of the grating bars;
a first grating bar of the first segment is the corresponding grating bar of a first grating bar of the second segment and a second grating bar of the first segment is the corresponding grating bar of a second grating bar of the second segment;
the distance is less than a period of the EPE grating;
each of said multiple bars in the second segment is offset from a corresponding grating bar in the first segment by the distance in a lateral direction;
each of said multiple bars in the second segment is offset from a corresponding grating bar in the first segment by the distance in a vertical direction;
the EPE grating is doubly periodic;
the first segment of the EPE grating is arranged to cause a first phase shift to a light ray deflected in the first segment and the second segment of the EPE grating is arranged to cause a second phase shift to a light ray deflected in the second segment;
the first phase shift is different compared to the second phase shift;
an amplitude of the light ray deflected in the first segment is the same as an amplitude of the light ray deflected in the second segment;
the second segment is subsequent to the first segment for a light ray guided to the EPE grating;
the EPE grating further comprises multiple grating bars in a third segment and each of said multiple bars in the third segment is offset from a corresponding grating bar in the first segment by a distance in a direction which is perpendicular to a direction of the grating bars;
a distance between subsequent grating bars of the first segment is the same as a distance between subsequent grating bars of the second segment;
the EPE grating is arranged to spread and couple light out of the EPE grating, and preferably also arranged to operate as an in-coupler;
the EPE grating is arranged to keep an amplitude of light rays propagating through different paths in the EPE grating as unaltered.

According to a second aspect of the present invention, there is provided an optical waveguide arrangement for displaying an image, comprising an optical waveguide, an in-coupling grating for diffractively coupling the image into the optical waveguide, an out-coupling grating for diffractively coupling the image out of the optical waveguide and an EPE grating according to any of the preceding claims, wherein the EPE grating is between the in-coupling grating and the out-coupling grating for expanding the exit pupil of the image on the out-coupling grating.

According to a third aspect of the present invention, there is provided a personal display device, such as a head-mounted display, HMD, or head-up display, HUD, comprising an optical waveguide arrangement according to the second aspect.

### BRIEF DESCRIPTION OF THE DRAWINGS

FIG. 1 illustrates an example system in accordance with at least some embodiments of the present invention;

FIG. 2a illustrates an example of an optical waveguide arrangement in accordance with at least some embodiments of the present invention;

FIG. 2b illustrates an example of an in-coupling grating, an exit pupil expander and an out-coupling grating in accordance with at least some embodiments of the present invention;

FIG. 3 illustrates an example of an exit pupil expander in accordance with at least some embodiments of the present invention;

FIG. 4 illustrates a first example of offset grating bars in accordance with at least some embodiments of the present invention;

FIGS. 5a and 5b illustrate a second example of offset grating bars in accordance with at least some embodiments of the present invention;

FIG. 6 illustrates an example of a phase shift in accordance with at least some embodiments of the present invention;

FIGS. 7a and 7b illustrate an example of an offset two-dimensional grating bar in accordance with at least some embodiments of the present invention;

FIG. 8 illustrates an example distribution of a moved distance in different segments in accordance with at least some embodiments of the present invention.

### EMBODIMENTS

Embodiments of the present invention relate to an Exit Pupil Expander, EPE, grating, e.g., for an optical waveguide arrangement. More specifically, embodiments of the present invention provide an EPE grating which reduces interference effects caused by light rays interfering in the EPE grating. According to the embodiments of the present invention, the EPE grating is divided into at least two segments with different phase shifts. Each of said at least two segments may comprise multiple grating bars and the grating bars of each segment may be arranged to cause different phase shifts, such as different phase shifts controlled according to Lohmann's detour-phase principle, when light rays propagate along different paths through the segments. The EPE grating may be thus arranged to keep an amplitude of light rays propagating along different paths as the same, i.e., unaltered, to provide more degrees of freedom for modifying the operation of an optical waveguide. For instance, the interference caused by light rays that interfere in the EPE grating can be reduced.

The EPE grating may comprise multiple grating bars in a first segment and multiple grating bars in a second segment, wherein said multiple grating bars of the first segment are misaligned compared to said multiple grating bars of the second segment. That is to say, the grating bars of the first and the second segments may not be in-line and each of said multiple bars in the second segment may be offset from a corresponding grating bar in the first segment by a distance in a direction which is perpendicular to a direction of the grating bars. That is to say, the offset may refer to a distance by which one grating bar is out of alignment with a corresponding grating bar.

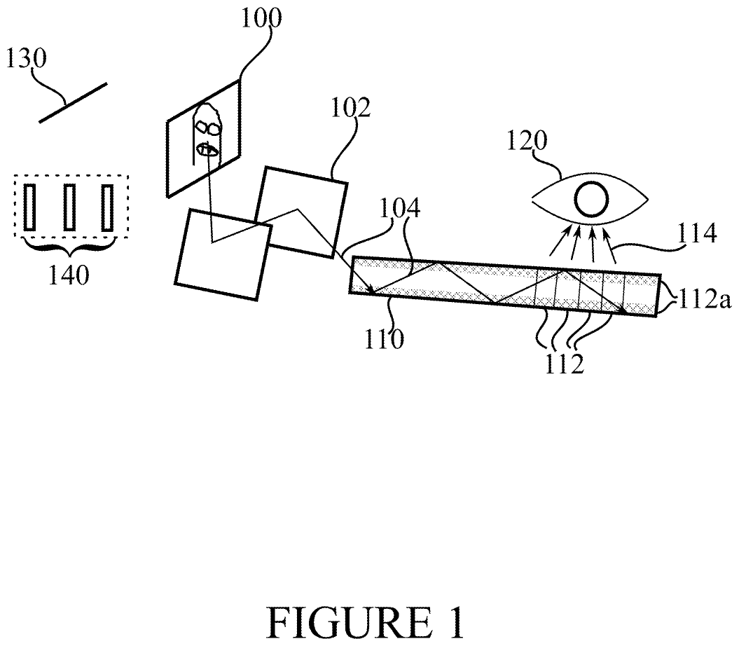

FIG. 1 illustrates an example system in accordance with at least some embodiments of the present invention. The system may comprise at least one light source 140. The at least one light source 140 may comprise laser or Light-Emitting Diode, LED, light source, for example, wherein laser sources have the advantage that they are more strictly monochromatic than LEDs. Embodiments of the present invention are not limited to any specific light source though and may be implemented using more than one type of light source 140. The at least one light source 140 together with an optional mirror 130 may be arranged to generate a light field in angular space which is usable in causing waveguide-based display to generate its image.

The image may be encoded in the light field. The light field is schematically illustrated in FIG. 1 as a field 100. In some embodiments, a physical primary display may display an image of the light field 100, while in other embodiments the system may comprise no physical primary display and the image is merely encoded in the light field 100 which is distributed in angular space. A light ray, or light signal, 104 from the light field 100 may be conveyed directly, or by, using optical guides 102 comprising, for example, mirrors and/or lenses, to an optical waveguide 110, to generate a waveguide-based display. The optical guides 102 are optional in the sense that depending on the specifics of a particular embodiment, they may be absent. In other words, the optical guides 102 are not present in all embodiments.

In the waveguide 110, the light ray 104 may advance by being reflected repeatedly inside the waveguide, interacting with elements 112a until it interacts with elements 112 which cause it to be deflected from waveguide 110 to air, toward an eye 120 as image producing light rays 114. Elements 112 and 112a may comprise transflective mirrors, surface relief gratings or other diffractive structures, for example. Elements 112a may be arranged, for example, to spread the light ray 104 inside the waveguide 110 such that the image of the waveguide display is correctly generated. Light from different angular aspects of the light field 100 will interact with the elements 112 so that light rays 114 will produce the image encoded in the light field 100 on the retina of the eye 120.

The elements 112 may then cause the light ray 104 to leave the waveguide 110 at an exit location. As a consequence, the user will perceive the image encoded in the light field 100 in front of his eye(s) 120. As the waveguide 110 may be, at least in part, transparent, the user may also advantageously see his real-life surroundings through the waveguide 110 in case the waveguide-based display is head-mounted, for example. Light is released from the waveguide 110 in multiple angles at multiple elements 112 as a consequence of the action of the elements 112a and 112. In a waveguide-based display, there may be present multiple waveguides 110, conveying light simulating different apparent depths in front of eye 120, as well as, optionally, the user's other eye which is not illustrated in FIG. 1 for the sake of clarity of the illustration.

In particular, embodiments of the present invention relate to an Exit Pupil Expander, EPE, e.g., for an optical waveguide arrangement, such as a lightguide-based diffractive display, comprising for example an in-coupling grating, the EPE, grating and an out-coupling grating. Optical waveguides are capable of conveying optical frequency light. By optical, or visible, frequencies it is meant light within about 400 to 700 nanometres in wavelength. Optical waveguides may be employed in displays, wherein light from a light field may be conveyed using one or more waveguides to suitable locations for release for a user's eye or eyes.

Embodiments of the present invention may be used for example in head-mounted displays, HMDs, and Head-Up Displays, HUDs, utilizing diffractive gratings. HMDs and HUDs can be implemented using optical waveguide technology, e.g., for augmented reality or virtual reality type applications. In augmented reality, a user sees a view of the real world and superimposed thereon supplementary indications. In virtual reality, the user is deprived of his view into the real world and provided instead a view into a software-defined scene. In general, there is a need to provide improvements related to the EPE grating, e.g., for an optical waveguide arrangement.

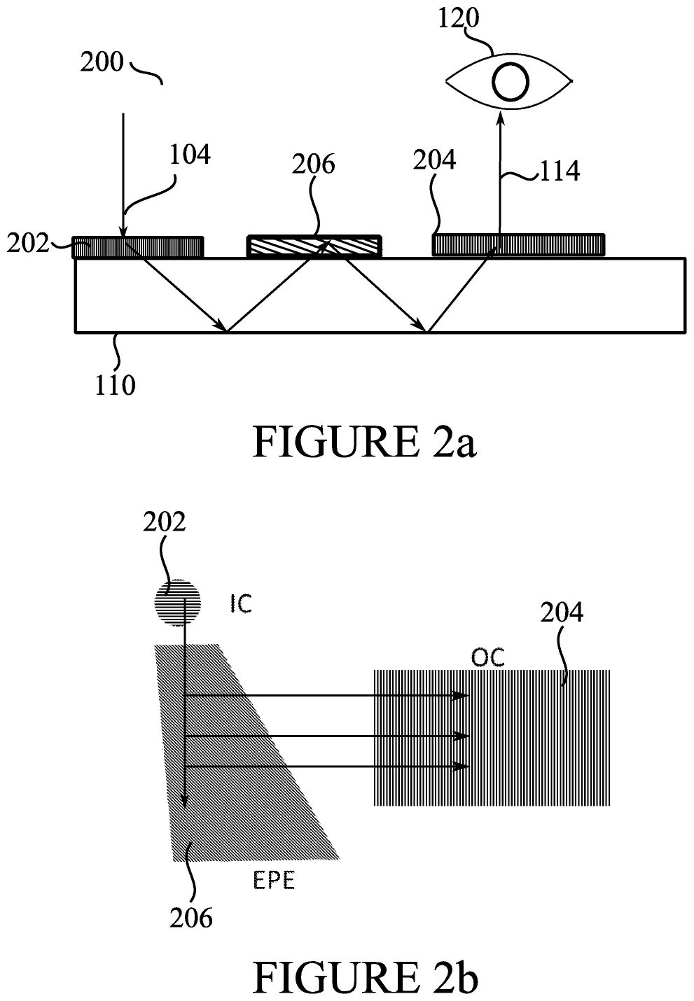

FIG. 2a illustrates an example of an optical waveguide arrangement in accordance with at least some embodiments of the present invention. The optical waveguide arrangement 200 may comprise the optical waveguide 110, an in-coupling grating 202, an out-coupling grating 204 and an EPE grating 206. In the example of FIG. 2a, the exit pupil of the optical waveguide arrangement 200 may be expanded using the EPE grating 206 between the in-coupling grating 202 and the out-coupling grating 204 of the optical waveguide arrangement 200.

As shown in FIG. 2a, light ray 104, for example from a light source 140 of FIG. 1 such as a projector, may be directed to the in-coupling grating 202. The in-coupling grating 202 may be arranged to guide the light ray 104 into the optical waveguide 110. That is to say, the in-coupling region 202 may diffractively couple an image into the optical waveguide 110. As shown in FIG. 2a, in some embodiments, the in-coupling grating 202 may be on a surface of the optical waveguide 110 for example. However, in some embodiments the optical waveguide 110 may comprise therein the in-coupling grating 202. Similarly, the optical waveguide 110 may comprise the out-coupling grating 204 and/or the EPE grating 206, or the in-coupling grating 202 and/or the EPE grating 206 may be on a surface of the optical waveguide 110.

The light ray 104 may propagate via internal reflections within the waveguide towards the out-coupling grating 204 via the EPE grating 206 to extend the viewable area of the display laterally. In some example embodiments, the EPE grating 206 may thus be between the in-coupling grating 202 and the out-coupling grating 204 along the path of light ray 104, to expand the exit pupil of an image on the out-coupling grating 204. Moreover, the out-coupling grating 204 may diffractively couple the image out of the optical waveguide 110 towards the eye 120, via light rays 114.

FIG. 2a demonstrates an example comprising the in-coupling grating 202, the out-coupling grating 204 and the EPE grating 206. However, in some embodiments, the EPE grating 206 may be arranged to spread and couple light out of the EPE grating 206. The EPE grating 206 may also be arranged to operate as an in-coupler. For instance, in case of 2D-structures the entire grating area may be made of the same grating from which the light rays are coupled in, spread and coupled out.

FIG. 2b illustrates an example of an in-coupling, IC, grating, an EPE and an out-coupling, OC, grating in accordance with at least some embodiments of the present invention. Light rays typically interfere in the EPE grating 206, for example when LED projectors are used as light sources 140, thereby causing non-uniformities (e.g. stripes) into the out-coupled image. Embodiments of the present invention therefore provide an improved EPE which provides more degrees of freedom for modifying the operation of an optical waveguide, e.g., to minimize non-uniformities in the image.

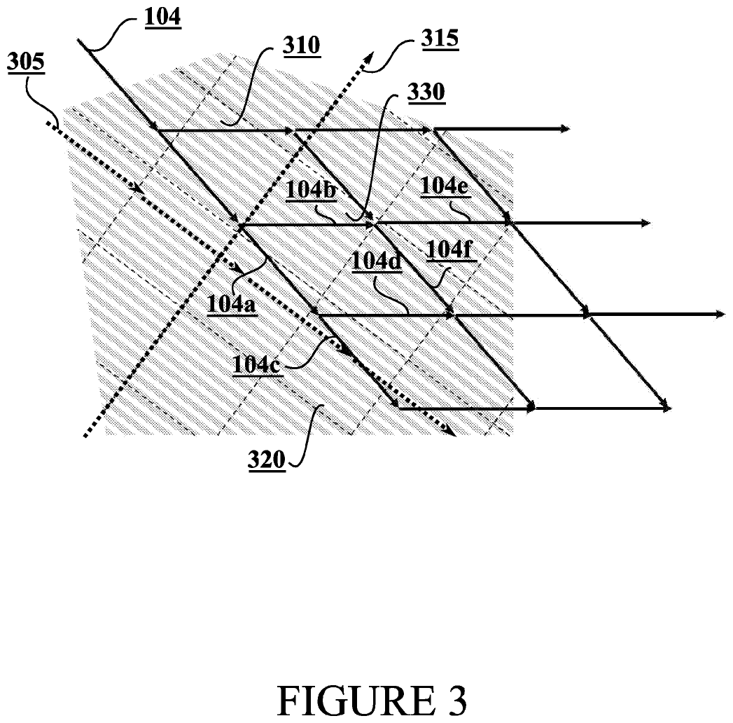

FIG. 3 illustrates an example of an EPE grating in accordance with at least some embodiments of the present invention. As shown in the example of FIG. 3, the EPE grating, such as the EPE grating 206 in FIG. 2, may be divided into segments. The dashed lines in FIG. 3 demonstrate borders of the segments. For instance, the EPE grating may be divided at least into a first segment 310 and a second segment 320 as shown in FIG. 3. More specifically, the EPE grating may be divided into segments which cause different phase shifts, such as phase shifts controlled according to Lohmann's detour phase principle. With properly chosen phase shifts, the interference effects can be reduced.

Each segment of the EPE grating 206 may comprise multiple grating bars and the grating bars of different segments may be arranged to generate diffracted versions of the incoming light ray with different phase shifts at each segment when light rays propagate along different paths through the segments. For instance, first segment 310 of the EPE grating 206 may comprise at least a first grating bar and second grating bar, and second segment 320 of the EPE grating 206 may comprise at least a first grating bar and second grating bar, and the grating bars of the first and the second segment may be arranged to cause different phase shifts to reduce interference caused by the light rays that interfere in the EPE grating 206.

In some example embodiments of the present invention, Lohmann's detour-phase principle may be exploited to reduce interference in the EPE grating so that when light diffracts from the grating it creates a set of reflected and transmitted diffraction orders with a certain phase and amplitude which are determined by the properties of the grating. If the relative positions of the grating bars are offset inside the period of the grating, it causes a phase shift which may be determined according to the following equation, e.g., for 1-dimensional case:

tₘ(ds)=tₘ*exp^{(-i*2π*m*}^{^{ds}}^{/d)}, (1)
wherein d denotes the period of the grating, ds is the shift in the position of the grating bars, m is the diffraction order of the light signal in question (e.g., −2, −1, 0, 1, 2) and tₘ=tₘ(0) is the amplitude of a grating in a case when the grating bars have not been shifted. Consequently, the phase of the non-zero diffraction orders may be adjusted by shifting the grating bars, while the amplitudes of all diffraction orders remain the same compared to a grating where the bars have not been shifted. Equation (1) may be generalized for 2-dimensional gratings for example using periods dx and dy with m and n diffraction orders in the x and y directions, respectively. The period of the grating d may be referred to as a distance between subsequent grating bars in one segment as well. Phase shifts may be controlled according to Lohmann's detour-phase principle as described by Joseph W. Goodman in “Introduction to Fourier Optics” 3rd Edition, 2004 (page. 360).

Thus, different phase shifts may be achieved by offsetting grating bars of one segment, such as the second segment 320, compared to an adjacent segment, such as the first segment 310, for example according to the Lohmann's detour phase principle. Interference caused by the light rays that interfere in the EPE grating 206 may be consequently reduced. The amplitude of the diffracted light rays remains the same though.

That is to say, amplitude distribution may change due to the entire EPE grating 206, but the EPE grating 206 may be arranged, e.g., to control phase shifts according to Lohmann's detour-phase principle, such that in case of a single grating occasion the amplitude does not change. Hence, phases of diffracted light rays may be controlled without altering the amplitude. More degrees of freedom are therefore provided for modifying operation of a waveguide. For instance, during initial design phase a waveguide may be designed without a phase first and then the amplitude may be kept as the same when phase shifts are modified to reduce interference.

A size of the offset may also vary depending on the segment and be optimized so that effects of interference can be minimized. Alternatively, or in addition, size of the segments may vary. That is to say, the first segment 310 may have a first size and the second segment 320 may have a second size, wherein the first size is different compared to the second size.

Concerning the example of FIG. 3, the incoming light ray 104 may be guided towards the grating bars of the first segment 310 of the EPE grating. The grating bars of the first segment 310 may diffract the incoming light ray 104 into a 0^{th} order light ray 104a and a 1^{st} order light ray 104b. Location of the grating bars in the first segment 310 does not affect the phase of the 0^{th} order light ray 104a but it does affect the phase of the 1^{st} order light ray 104b. The 0^{th} order light ray 104a may be referred to as a non-deflected light ray and a 1^{st} order light ray 104b may be referred to as a deflected light ray. Light rays of other non-zero diffraction orders (i.e., m=(−2, −1, 1, 2)) may be referred to as deflected light rays.

That is to say, the 0^{th} order light ray 104a may be a light ray that continues straight, i.e., does not turn. The 1^{st} order light ray 104b may be a light ray that does not continue straight, i.e., it turns.

The diffracted 0^{th} order light ray 104a may be further guided from the first segment 310 towards the gratings bars of the second segment 320 and the grating bars of the second segment 320 may diffract the incoming 0^{th} order light ray 104a into a 0^{th} order light ray 104c and a 1^{st} order light ray 104d. Again, location of the grating bars in the second segment 320 does not affect the phase of the 0^{th} order light ray 104c but it does affect the phase of the 1^{st} order light ray 104d. Also, the 0^{th} order light ray 104c may be referred to as a non-deflected light ray and a 1^{st} order light ray 104d may be referred to as a deflected light ray.

Moreover, the diffracted 1^{st} order light ray 104b may be further guided from the first segment 310 towards gratings bars of the third segment 330 and the grating bars of said third segment 330 may diffract the light ray 104b into a non-deflected light ray 104e and a deflected light ray 104f. The light rays may be similarly guided through several segments of the EPE.

The light rays deflected in different segments may have different phases, i.e., different segments may cause different phase shifts to deflected light rays, but amplitudes of the deflected light rays (and non-deflected light rays) may be the same. For instance, the first segment 310 may be arranged to cause a first phase shift to the light ray 104b deflected in the first segment 310 and the second segment 320 may be arranged to cause a second phase shift to the light ray 104d deflected in the second segment 320. The first phase shift may be different compared to the second phase shift while an amplitude of the light ray deflected in the first segment 310 may be the same as an amplitude of the light ray deflected in the second segment 320. The light rays propagating along different paths may hit the same location and interfere, but such interference can be controlled by tuning the phases of the light rays.

The grating bars of each segment may be arranged to a same direction 305, but the grating bars of at least some segments may be offset relative to a corresponding grating bar in an adjacent segment to a direction 315 which is perpendicular to the direction 305 of the grating bars, to cause the diffracted light rays propagating along different paths to have different phase shifts. For instance, each of said multiple bars of the second segment 320 may be moved, i.e., offset, from a corresponding grating bar of the first segment 310 by a distance in the direction 315 which is perpendicular to the direction 305 of the grating bars.

That is to say, a phase shift may be realized into deflected light rays by moving the grating bars within a distance between subsequent grating bars in one segment. The phase of the non-deflected light rays 104a, 104c, 104e may not be shifted though and amplitudes of all diffraction orders may remain the same regardless of the phase shift.

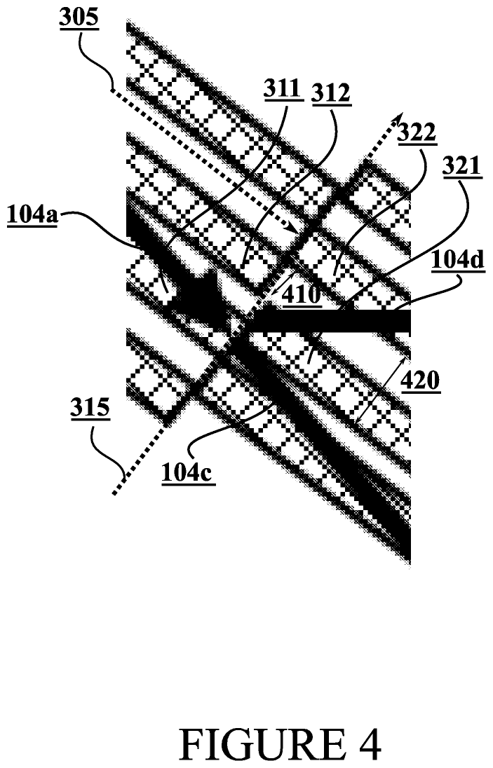

FIG. 4 illustrates a first example of offset grating bars in accordance with at least some embodiments of the present invention. More specifically, FIG. 4 illustrates how a first grating bar 321 and a second grating bar 322 of the second segment 320 may be offset compared to a corresponding first grating bar 311 and a second grating bar 312 of the first segment 320, respectively, by a distance 410 in the direction 315 which is perpendicular to the direction 305 of the grating bars. That is to say, the first grating bar 311 of the first segment 310 may be the corresponding grating bar of the first grating bar 321 of the second segment 320 and the second grating bar 312 of the first segment 310 may be the corresponding grating bar of the second grating bar 322 of the second segment 320.

Thus, the first grating bar 321 of the second segment 320 may be offset from the corresponding grating bar, i.e., the first grating bar 311, of the first segment 310 by the distance 410. Similarly, the second grating bar 322 of the second segment 320 may be offset from the corresponding grating bar, i.e., the second grating bar 312, of the first segment 310 by the distance 410 as well. Consequently, the first grating bar 311 and the second grating bar 312 of the first segment 310 would be misaligned compared to corresponding first grating bar 321 and second grating bar 322 of the second segment 320 in the direction 315 which is perpendicular to the direction 305 of the grating bars, thereby causing light rays propagating along different paths in the EPE grating to undergo different phase shifts even though the amplitude of the diffracted light rays remains the same. That is to say, all grating bars of the second segment 320 may be offset by the same distance 410 compared to a corresponding grating bar of the first segment 310.

The distance 410 may be less than a distance 420 between adjacent grating bars of one segment. That is to say, the distance 410 may be less than a period of the EPE grating. For instance, if the EPE grating comprises two grating bars within the period of the EPE grating, both grating bars may be offset by the same amount.

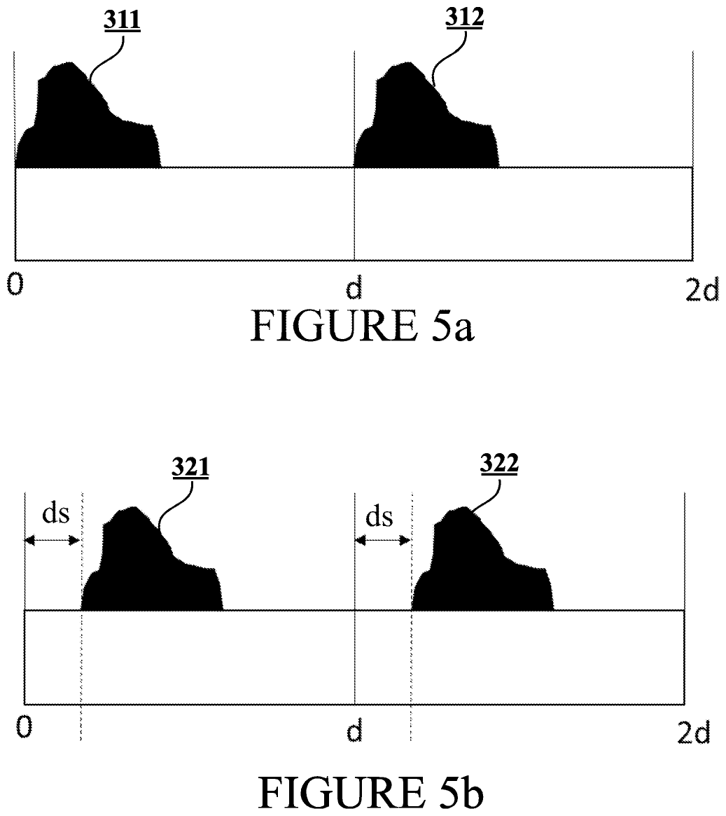

FIGS. 5a and 5b illustrate a second example of offset grating bars in accordance with at least some embodiments of the present invention. More specifically, FIGS. 5a and 5b illustrate how each of said multiple bars of the second segment 320 may be offset from a corresponding grating bar of the first segment 310 by a distance ds in the direction 315 which is perpendicular to the direction 305 of the grating bars, such as in the lateral direction. The distance ds (as in Equation (1)) may correspond to the distance 410 in FIG. 4. The distance between subsequent grating bars of one segment, such as the first grating bar 311 and the second grating bar 312 of the first segment 310, is denoted by d (as in Equation (1)) which may correspond to the distance 420 in FIG. 4.

That is to say, the first grating bar 321 of the second segment 320 in FIG. 5b may be offset by the distance ds compared to the first grating bar 311 of the first segment 310 in FIG. 5a and the second grating bar 322 of the second segment 320 in FIG. 5b may be offset by the distance ds compared to the second grating bar 312 of the first segment in FIG. 5a. Thus, a phase shift may be realized into diffracted orders, i.e., deflected light rays, by moving the grating bars of one segment compared to grating bars of another segment within the distance between subsequent grating bars in one segment, i.e., within period d. As shown in FIG. 5b, for example the first grating bar 321 of the second segment 320 may be offset by the distance ds compared to the first grating bar 311 of the first segment 310 on a plane of the grating bars in case of one-dimensional grating bars, e.g., in a lateral direction. The lateral direction may refer to a direction which extends from one side of the EPE grating to another side of the EPE grating.

FIGS. 5a and 5b show a cross-sectional view of the grating bars 311, 312, 321 and 322. The grating bars may in general have various shapes. However, embodiments of the present invention are not limited to any particular shape of the grating bars. For instance, the cross-sectional profile of the grating bars may also be rectangular or triangular. Moreover, width, height, fill factor or any other characteristic of the grating bars may vary depending on the segment, e.g., the grating bars of the first segment 310 may have a different width compared to the second segment 320.

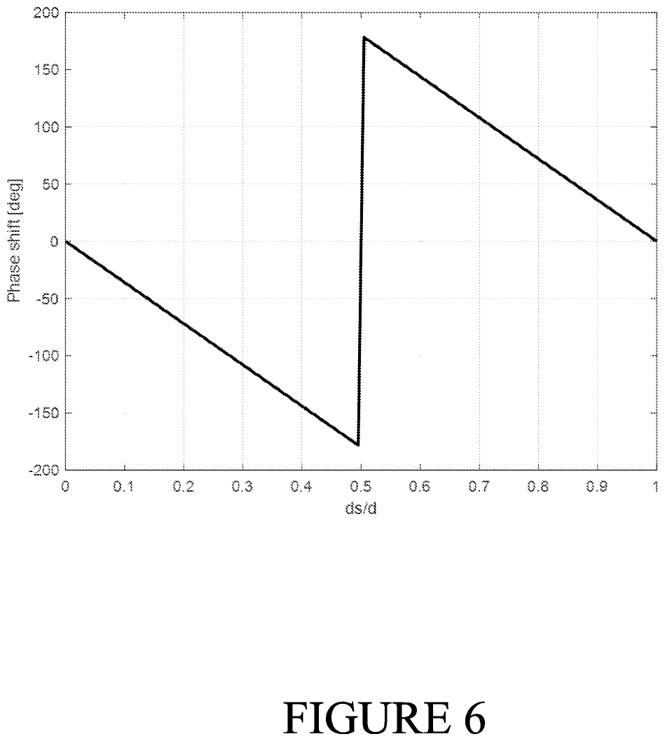

FIG. 6 illustrates an example of a phase shift in accordance with at least some embodiments of the present invention. More specifically, FIG. 6 illustrates an example of a phase shift as a function of a ratio of ds/d. In FIG. 6, phases of an electric field component of a 1st diffraction order as a function of Lohmann shift ds.

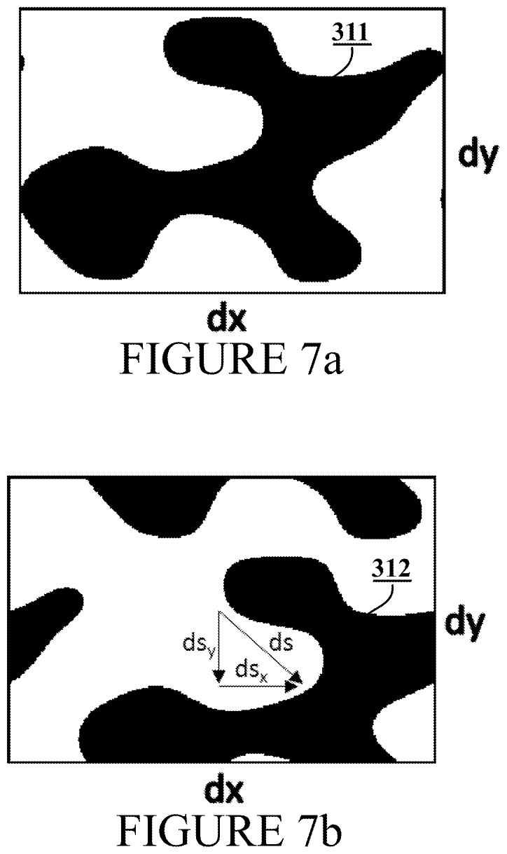

FIGS. 7a and 7b illustrate an example of an offset two-dimensional grating bar in accordance with at least some embodiments of the present invention. That is to say, FIGS. 7a and 7b illustrate an example of a doubly periodic grating bar.

More specifically, FIGS. 7a and 7b illustrate how embodiments of the present invention may be applied to two dimensional EPE gratings. FIG. 7a illustrates a location of the first grating bar 311 of the first segment 310 and FIG. 7b illustrates a location of the first grating bar 321 of the second segment 320. As can be seen from FIG. 7b, in case of two-dimensional gratings the first grating bar 321 of the second segment 320 may be offset on a plane of the grating bars, i.e., in a lateral direction dx, and also on a plane that is perpendicular to the plane of the grating bars, i.e., in a vertical direction dy. The vertical direction may refer to a direction which extends from a bottom of the EPE grating to the top of the EPE grating. Similarly as in the examples shown in FIGS. 5a and 5b, the grating bars shown in FIGS. 7a and 7b may also have any shape or other characteristic, such as rectangular shape or triangular shape for example.

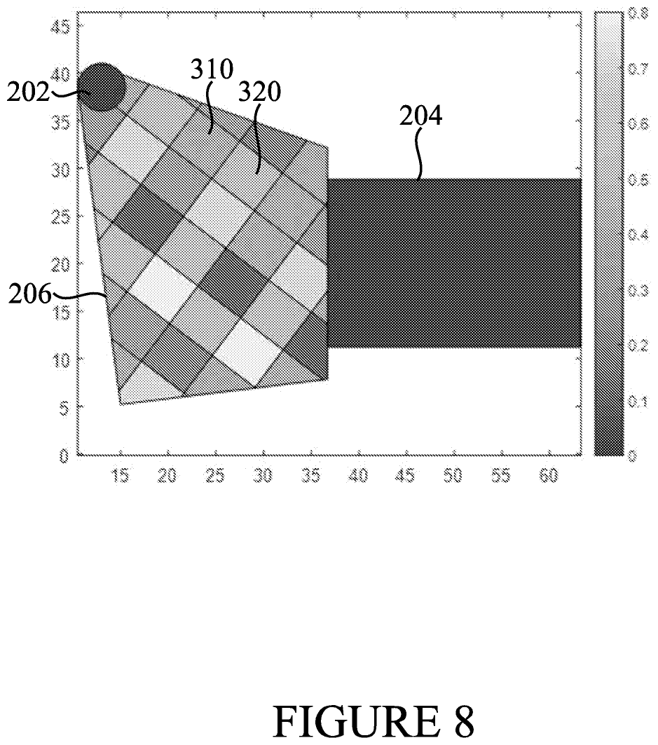

FIG. 8 illustrates an example distribution of a moved distance in different segments in accordance with at least some embodiments of the present invention. In FIG. 8, the in-coupling grating 202, the out-coupling grating 204 and the EPE grating 206. As shown in FIG. 8, the segments of the EPE grating 206, such as the first segment 310 and the second segment 320, may be arranged to cause different phase shifts into diffracted light rays while keeping the amplitudes of the diffracted light rays as the same by moving grating bars of different segments by different distances, thereby reducing interference caused by light rays that interfere in the EPE grating 206.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in HMDs and HUDs.

### ACRONYMS LIST

HMD Head-Mounted Display
HUD Head-Up Display
LCOS Liquid Crystal on Silicon
LED Light-Emitting Diode
MEMS Microelectromechanical System
REFERENCE SIGNS LIST

| | |
|---|---|
| 100 | light field |
| 102 | optical guides |
| 104 | light rays |
| 110 | waveguide |
| 112 | elements |
| 114 | directed light |
| 120 | eye(s) |
| 130 | mirror |
| 140 | light sources |
| 202 | in-coupling grating |
| 204 | out-coupling grating |
| 206 | exit pupil expander |
| 310, 320 | segments of the EPE |
| 311, 312, 321, 322 | grating bars |
| 305, 315 | directions |
| 410 | distance ds |
| 420 | distance d |

1. An Exit Pupil Expander, EPE, grating which is divided into at least two segments, comprising: multiple grating bars in a first segment and multiple grating bars in a second segment, said multiple grating bars of the first segment being directed about to a same direction as said multiple grating bars of the second segment and misaligned in a direction which is perpendicular to the direction of the grating bars.

2. The EPE grating according to claim 1, wherein said multiple grating bars of the first segment and said multiple grating bars of the second segment are misaligned to cause light rays propagating along different paths in the EPE grating to undergo different phase shifts.

3. The EPE grating according to claim 1, wherein each of said multiple grating bars in the second segment is offset compared to a corresponding grating bar in the first segment by a distance in the direction which is perpendicular to a direction of the grating bars.

4. The EPE grating according to claim 3, wherein a first grating bar of the first segment is the corresponding grating bar of a first grating bar of the second segment and a second grating bar of the first segment is the corresponding grating bar of a second grating bar of the second segment.

5. The EPE grating according to claim 3, wherein the distance is less than a period of the EPE grating.

6. The EPE grating according to claim 1, wherein each of said multiple bars in the second segment is offset from a corresponding grating bar in the first segment by the distance in a lateral direction.

7. The EPE grating according to claim 1, wherein each of said multiple bars in the second segment is offset from a corresponding grating bar in the first segment by the distance in a vertical direction.

8. The EPE grating according to claim 1, wherein the EPE grating is doubly periodic.

9. The EPE grating according to claim 1, wherein the first segment of the EPE grating is arranged to cause a first phase shift to a light ray deflected in the first segment and the second segment of the EPE grating is arranged to cause a second phase shift to a light ray deflected in the second segment.

10. The EPE grating according to claim 9, wherein the first phase shift is different compared to the second phase shift.

11. The EPE grating according to claim 9, wherein an amplitude of the light ray deflected in the first segment is the same as an amplitude of the light ray deflected in the second segment.

12. The EPE grating according to claim 1, wherein the second segment is subsequent to the first segment for a light ray guided to the EPE grating.

13. The EPE grating according to claim 1, wherein the EPE grating further comprises multiple grating bars in a third segment and each of said multiple bars in the third segment is offset from a corresponding grating bar in the first segment by a distance in a direction which is perpendicular to a direction of the grating bars.

14. The EPE grating according to claim 1, wherein a distance between subsequent grating bars of the first segment is the same as a distance between subsequent grating bars of the second segment.

15. The EPE grating according to claim 1, wherein the EPE grating is arranged to spread and couple light out of the EPE grating, and preferably also arranged to operate as an in-coupler.

16. The EPE grating according to claim 1, wherein the EPE grating is arranged to keep an amplitude of light rays propagating through different paths in the EPE grating as unaltered.

17. An optical waveguide arrangement for displaying an image, comprising:
an optical waveguide;
an in-coupling grating for diffractively coupling the image into the optical waveguide;
an out-coupling grating for diffractively coupling the image out of the optical waveguide; and
an EPE grating according to any of the preceding claims, wherein the EPE grating is between the in-coupling grating and the out-coupling grating for expanding the exit pupil of the image on the out-coupling grating.

18. The optical waveguide arrangement according to claim 17, wherein the optical waveguide arrangement includes a personal display device, such as a head-mounted display, HMD, or head-up display, HUD.
